(19) United States
(12) Patent Application Publication
(10) Pub. No.: US 2025/0209306 A1
(43) Pub. Date: Jun. 26, 2025

(54) PREDICTING USER INPUT DEVICE ACTIVITY USING MACHINE LEARNING TECHNIQUES

(71) Applicant: Dell Products L.P., Round Rock, TX (US)

(72) Inventors: Rajiv Popat, Kolkata (IN); Bijan Kumar Mohanty, Austin, TX (US); Hung T. Dinh, Austin, TX (US)

(21) Appl. No.: 18/390,767

(22) Filed: Dec. 20, 2023

(51) Int. Cl. G06N 3/0455; G06N 3/088

(52) U.S. Cl. CPC G06N 3/0455; G06N 3/088

(57) ABSTRACT

Methods, apparatus, and processor-readable storage media for predicting user input device activity using machine learning techniques are provided herein. An example computer-implemented method includes obtaining data pertaining to at least one of input device-related movement and input device-related action, and associated with a user using an application at a first temporal instance; predicting at least one of one or more input device-related movements and one or more input device-related actions to be carried out, at a second temporal instance subsequent to the first temporal instance, in connection with the user using the application, by processing at least a portion of the obtained data using one or more machine learning techniques; and performing one or more automated actions based at least in part on the at least one of the one or more predicted input device-related movements and the one or more predicted input device-related actions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Input devices are versatile and important parts of computing systems. Such devices can, for example, be used to enter information to computing systems via a variety of actions such as keying, scanning, recording, pointing, etc. Conventional input device management techniques commonly involve frequent and repetitive manual movements by users of an input device proxy (e.g., a pointer) on a screen to reach and/or navigate controls, buttons, menus, sub-menus, dialog boxes, etc. As such, users spend considerable time moving the input device and actively selecting options on the screen to express their intent.

### SUMMARY

Illustrative embodiments of the disclosure provide techniques for predicting user input device activity using machine learning techniques.

An exemplary computer-implemented method includes obtaining data pertaining to at least one of input device-related movement and input device-related action, and associated with a user using an application at a first temporal instance. The method also includes predicting at least one of one or more input device-related movements and one or more input device-related actions to be carried out, at a second temporal instance subsequent to the first temporal instance, in connection with the user using the application, by processing at least a portion of the obtained data using one or more machine learning techniques. Additionally, the method includes performing one or more automated actions based at least in part on the at least one of the one or more predicted input device-related movements and the one or more predicted input device-related actions.

Illustrative embodiments can provide significant advantages relative to conventional input device management techniques. For example, problems associated with time-consuming and repetitive physical user movements are overcome in one or more embodiments through automatically predicting and/or recommending one or more input device movements and/or actions using one or more machine learning techniques and based a given preceding input device action and historical activity data associated with multiple input devices and users.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for predicting user input device activity using machine learning techniques in an illustrative embodiment.

FIG. 2 shows example architecture of a machine learning-based input device action prediction system in an illustrative embodiment.

FIG. 3 shows example pseudocode for preprocessing clickstream data in an illustrative embodiment.

FIG. 4 shows example pseudocode for encoding textual values into numerical values in an illustrative embodiment.

FIG. 5 shows example pseudocode for implementing input data as a Numpy array in an illustrative embodiment.

FIG. 6 shows example pseudocode for creating an autoencoder with long short-term memory-based (LSTM-based) encoder and decoder layers in an illustrative embodiment.

FIG. 7 shows example pseudocode for configuring an encoder model and a decoder model to predict the next action in a sequence in an illustrative embodiment.

FIG. 8 shows example pseudocode for predicting, using a trained model, the next action in a sequence of actions based on a current action in an illustrative embodiment.

FIG. 9 is a diagram of an example display of a suggested input device action in connection with a given application in an illustrative embodiment.

FIG. 10 is a flow diagram of a process for predicting user input device activity using machine learning techniques in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

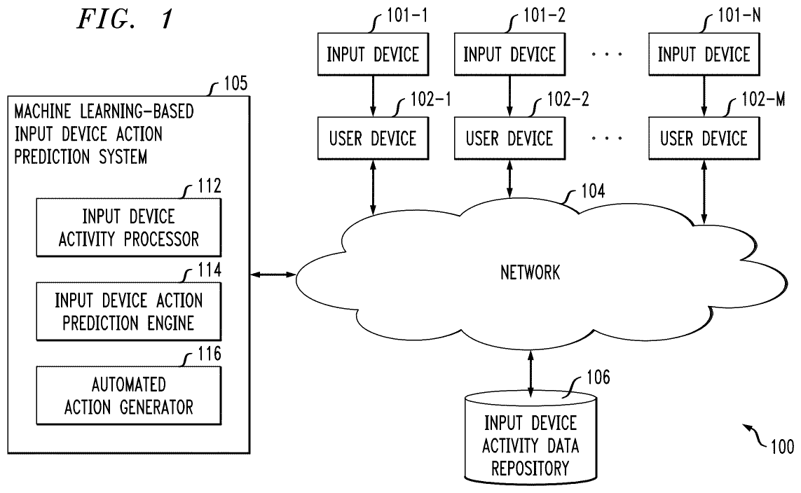

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is machine learning-based input device action prediction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The user devices 102 are also linked to a plurality of input devices 101-1, 101-2, . . . 101-N, collectively referred to herein as input devices 101. Input devices 101 can include a variety of devices that input data into any computing system such as, for example, one or more pointing devices (e.g., a mouse, a trackball, a light pen, a touch pad, a touch screen, a stylus, etc.), one or more gaming input devices (e.g., a joystick, a gamepad, etc.), and/or one or more text and/or character input devices (e.g., a keyboard, a barcode reader, etc.), and such input devices can control the movement of and/or the execution of action via one or more input device proxies (e.g., an arrow on a screen and/or interface, etc.).

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the machine learning-based input device action prediction system 105 can have an associated input device activity data repository 106 configured to store data pertaining to movement of an input device and/or input device proxy in connection with one or more applications, actions initiated and/or executed by an input device and/or input device proxy in connection with one or more applications, user information associated with one or more input devices, etc.

The input device activity data repository 106 in the present embodiment is implemented using one or more storage systems associated with the machine learning-based input device action prediction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the machine learning-based input device action prediction system 105 can be one or more auxiliary devices, which illustratively comprise keyboards, displays or other types of auxiliary devices in any combination. Such auxiliary devices can be used, for example, to support one or more user interfaces to the machine learning-based input device action prediction system 105, as well as to support communication between the machine learning-based input device action prediction system 105 and other related systems and devices not explicitly shown.

Additionally, the machine learning-based input device action prediction system 105 in the FIG. 1 embodiment is assumed to be implemented using at least one processing device. Each such processing device generally comprises at least one processor and an associated memory, and implements one or more functional modules for controlling certain features of the machine learning-based input device action prediction system 105.

More particularly, the machine learning-based input device action prediction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the machine learning-based input device action prediction system 105 to communicate over the network 104 with the user devices 102, and illustratively comprises one or more conventional transceivers.

The machine learning-based input device action prediction system 105 further comprises input device activity processor 112, input device action prediction engine 114, and automated action generator 116.

It is to be appreciated that this particular arrangement of elements 112, 114 and 116 illustrated in the machine learning-based input device action prediction system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for predicting user input device activity using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, machine learning-based input device action prediction system 105 and input device activity data repository 106 can be on and/or part of the same processing platform.

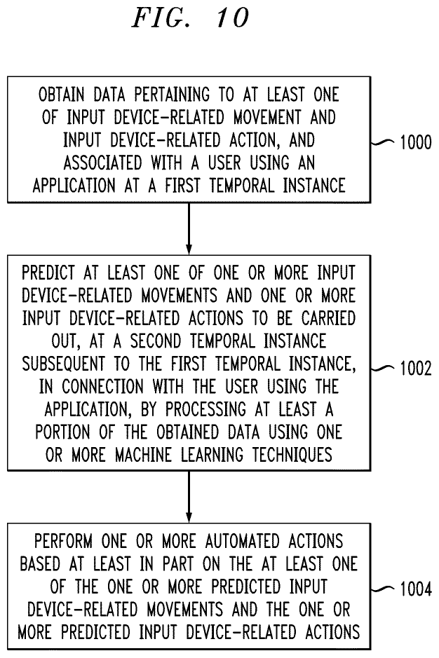

An exemplary process utilizing elements 112, 114 and 116 of an example machine learning-based input device action prediction system 105 in computer network 100 will be described in more detail with reference to the flow diagram of FIG. 10.

Accordingly, at least one embodiment includes predicting user input device activity using machine learning techniques. More particularly, such an embodiment can include automatically predicting user input device-related behavior using machine learning techniques in conjunction with input device activity data derived from multiple users (also referred to herein as community learning). Such community learning can encompass and/or process data from at least one community of users (e.g., users on the same team as a user in question, users within the same enterprise, etc.) using similar devices as a user in question.

For example, by obtaining and storing (e.g., in the cloud) clickstream data (e.g., input device-related movement data and/or input device-related action data) of a set of users, and using at least a portion of such data to train one or more machine learning techniques (e.g., one or more local models and/or one or more community models), at least one embodiment includes learning and/or predicting users' usage patterns with respect to at least one input device, thereby rendering the users more productive and efficient.

Accordingly, such an embodiment can include learning user behaviors in various applications. For instance, while working on an application, clickstream data encompassing the user's selections and/or clicking of at least one menu option is captured and analyzed. For example, if a user opens an integrated development environment and click on the “Tools” menu, followed by clicking an “Options” sub-menu, both the application executable name and the handles (i.e., unique names and/or identifiers (IDs) for each control used by an operating system (OS) available in programming frameworks and languages) of the menu items can be captured along with a pixel map (e.g., coordinates) that the input device took to traverse to those menu and/or sub-menu options.

One or more embodiments also include managing clickstream data for multiple users using multiple applications. For example, during the use of input devices while working with various applications, the clickstream data of the users can be sent to and/or obtained by a server, which stores and manages such data in an input device activity data (e.g., clickstream data) repository for future analysis and training purposes. Metadata associated with such clickstream data can include the user information (e.g., identity), the application name, clickstream coordinates (e.g., coordinates capturing the move and click actions of the user input device), options used by the user in the application, the date and/or time of use, etc. At least a portion of such metadata can be used to train at least one machine learning algorithm to learn specific user behavior and predict the next movement(s) and/or action(s) of the user via the user's input device based at least in part on the current position of the input device and/or input device proxy (e.g., an arrow on a screen associated with a mouse device) and movement as identified from pixel coordinates. Such pixel coordinates refer to pixel coordinates on a computer screen and/or display, and such coordinates can be determined, for example, relative to a fixed point referred to an origin and defined in terms of X and Y coordinates from the origin. In at least one example embodiment, the origin can be the top-left corner of the screen/display and/or application window.

Additionally, as detailed herein, one or more embodiments include generating local behavior predictions and global predictions using community learning. Clickstream data of multiple users are captured and stored in an input device activity data repository, including community metadata which can be used for global predictions that can introduce new behaviors for any of the users. This capability can not only include recommending the most frequently used behavior of a given user from the user's historical data, but can also include recommending what action(s) or movement(s) other users are taking for the given application in use. At least one embodiment can include building and/or training two separate machine learning models, a local model and a global model, for two different types of predictions, which can enhance the productivity of all users in the set of users.

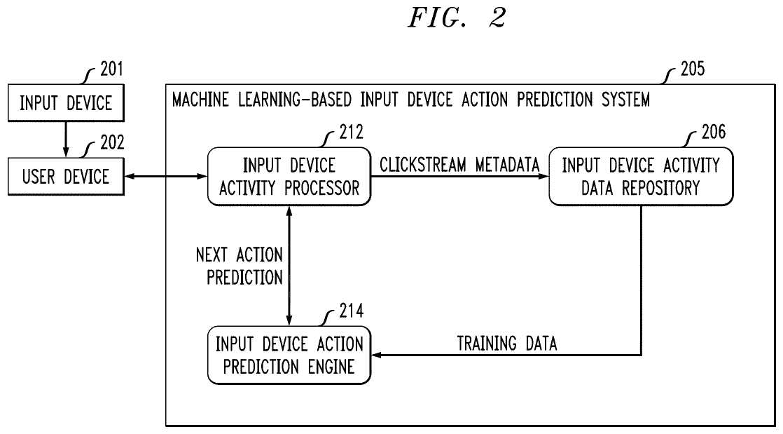

FIG. 2 shows example architecture of a machine learning-based input device action prediction system in an illustrative embodiment. By way of illustration, the example architecture depicted in FIG. 2 includes machine learning-based input device action prediction system 205, which contains the elements of input device activity processor 212, input device activity data repository 206, which stores historical community clickstream data and/or metadata, and input device action prediction engine 214. In an example embodiment, the input device activity data repository 206 receives and manages clickstream data and/or metadata from a given community of users using multiple input devices (e.g., input device 201) in association with one or more user devices (e.g., user device 202). Also, the input device action prediction engine 214 is trained using at least a portion of the data stored in input device activity data repository 206.

Further, in generating an input device action prediction and/or recommendation in accordance with at least one embodiment, a user, via input device 201 in connection with an application utilized on user device 202, starts and/or makes one or more movements and/or actions. Such movement(s) and/or action(s) is captured and/or processed by input device activity processor 212, which provides at least a portion of such data to input device action prediction engine 214. In one or more embodiments, the capturing and/or processing of such data from input device 201 by input device activity processor 212 is facilitated by one or more device drivers. For example, when an input device such as input device 201 is connected to a computing system such as user device 202 (e.g., through universal serial bus (USB), USB-C, Bluetooth, etc.), one or more device drivers send data pertaining to the activity on the input device to the computing system's operating system, which acts (e.g., moves an arrow, types a letter and/or number, etc.) as per the action done on the input device. Using one or more machine learning techniques, input device action prediction engine 214 predicts the next movement(s) and/or action(s) of activity by input device 201, wherein such a prediction is output and/or communicated to user device 202 via input device activity processor 212.

With respect to the input device activity data repository 206, historical clickstream data and/or metadata is stored for subsequent use as an indicator for predicting (by the input device action prediction engine 214) the next action(s) of the given user (e.g., via user device 202) for a given in-use application using a given input device (e.g., input device 201). Accordingly, one or more embodiments include building and/or implementing at least one input device activity data repository that receives the clickstream data and/or metadata of all users in a given set of users (e.g., users within a given team and/or within a given enterprise, etc.) for multiple applications and multiple types of input devices (associated with one or more user devices) in at least one centralized repository. Such clickstream data and/or metadata can include, for example, user identifier information, type(s) of user (e.g., commercial or consumer), special ability of the user(s) if any, device identifier information, type of input device (e.g., mouse, keyboard, joystick, etc.), application(s) being used, the coordinates (e.g., X and Y coordinates) of the input device proxy (e.g., a pointer), control handle information, clickstream identifier information, the step number in that clickstream, etc.

In at least one embodiment, data engineering and data preprocessing are carried out on obtained clickstream data to understand one or more features and/or one or more data elements that will influence the predictions for subsequent input device actions. As further detailed herein, such analysis can include using multivariate plots and correlation heatmaps to identify the significance of each feature in the dataset such that un-important and/or less important data elements are filtered out from the dataset. Such analysis reduces the dimensionality and complexity of the given model, thereby improving the accuracy and performance of the model.

As also detailed herein, one or more embodiments include implementing an input device action prediction engine, which is responsible for predicting the next input device action(s) in a sequence of actions based at least in part on historical sequence of events within clickstream data. The prediction of future actions from current actions using historical actions data is carried out using at least one machine learning technique such as, for example, a sequence model. Sequence models, as described herein, are designed to work with sequences of input data, such as a sequence of actions, and can be trained on historical action data and used to predict the next action in a particular sequence given the current action.

In at least one embodiment, one or more deep neural network-based algorithms such as, for example, one or more recurrent neural networks (RNNs) and/or one or more LSTM networks are particularly suited for such tasks as noted above and detailed herein because such deep neural network-based algorithms can model temporal dependencies between actions in a sequence. Accordingly, the neural network can take into account the order in which actions occurred, which is important for predicting future actions based on past actions.

One or more embodiments include leveraging a LSTM network that is trained in an unsupervised manner to learn one or more underlying patterns and relationships between actions in a set of historical input device action data. The LSTM network can then be used to predict, for a given user and corresponding input device in connection with a given application, the next action(s) in a sequence based on the current action, without being explicitly trained on a labeled dataset of actions.

To use the LSTM network in an unsupervised manner, such an embodiment includes implementing an autoencoder architecture. A goal of an autoencoder is to learn a representation and/or feature (also referred to herein as an encoding) for a set of data, often for dimensionality reduction. Along with the reduction side, a reconstructing side can be learned wherein the autoencoder attempts to generate, from the reduced encoding, a representation as close as possible to the original input. By way of example, in such an embodiment, an autoencoder will input data parameters such as application identifying information, device identifying information, device type, X and Y coordinates of the input device proxy, clickstream data, action event identifying information, etc., and by performing encoding and decoding will learn the correlation between at least a portion of these parameters for learning one or more user device action patterns.

As used herein, autoencoders are a form of feed-forward neural networks called artificial neural network (ANNs) or multi-layer perceptrons (MLPs). Such feed-forward neural networks can include, for example, an input layer, an output layer and one or more hidden layer therebetween. In one or more embodiments, the output layer will have the same number of nodes as the input layer. In this approach, the LSTM network using an autoencoder is trained to reconstruct its input sequence from a compressed representation, or “code” of the input sequence. The LSTM network is used to encode the input sequence into a compressed representation, and then another LSTM network is used to decode the compressed representation back into the original sequence.

For example, an encoder can process an input of timesteps and features with values, wherein such processing results in one or more encoded features. The one or more encoded features can then be duplicated to create an array of timestamps and features to be used as input for the decoder. Processing of the array by the decoder can result in creating a dense layer of a given size, which can then be duplicated in accordance with a given parameter and used to produce an output that is close and/or similar to the input.

During training, the autoencoder can be enhanced and/or optimized to reduce and/or minimize the difference between the original input sequence and the reconstructed sequence. After training the encoder, part of the network is used as a predictor of the next action in the sequence based on the current action.

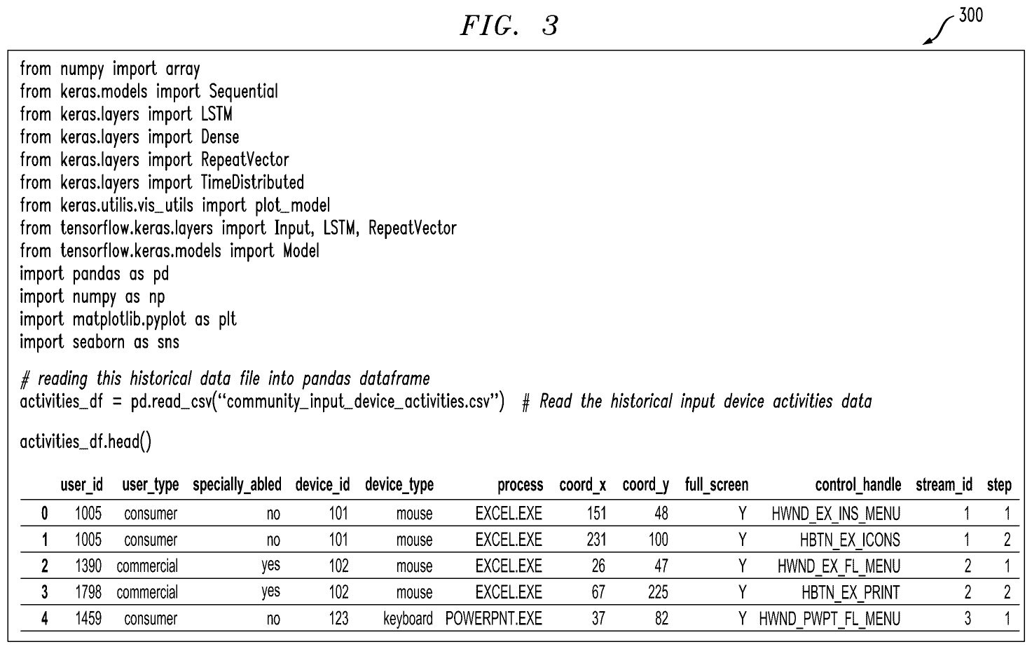

The implementation of an LSTM such as detailed above and used in one or more embodiments can be achieved as depicted, e.g., in FIG. 3 through FIG. 8, by using Keras with a Tensorflow backend, Python language, and Pandas, Numpy and ScikitLearn libraries.

FIG. 3 shows example pseudocode for preprocessing clickstream data in an illustrative embodiment. In this embodiment, example pseudocode 300 is executed by or under the control of at least one processing system and/or device. For example, the example pseudocode 300 may be viewed as comprising a portion of a software implementation of at least part of machine learning-based input device action prediction system 105 of the FIG. 1 embodiment.

The example pseudocode 300 illustrates clickstream data preprocessing, which includes reading the dataset of an historical clickstream activities data file and generating a Pandas dataframe. The dataframe contains all of the columns that are the features for training the LSTM. Because one or more embodiments include an unsupervised learning approach, there would not be a target column for such an embodiment. One data preprocessing step includes handling any null or missing values in the columns. For example, null and/or missing values in numerical columns can be replaced by the median value of that column. After performing initial data analysis by creating one or more univariate and bivariate plots of the columns, the importance and influence of each column can be learned and/or understood. Columns that have limited or no role or influence on the actual prediction (i.e., the target variable) can be removed and/or filtered out.

It is to be appreciated that this particular example pseudocode shows just one example implementation of preprocessing clickstream data, and alternative implementations can be used in other embodiments.

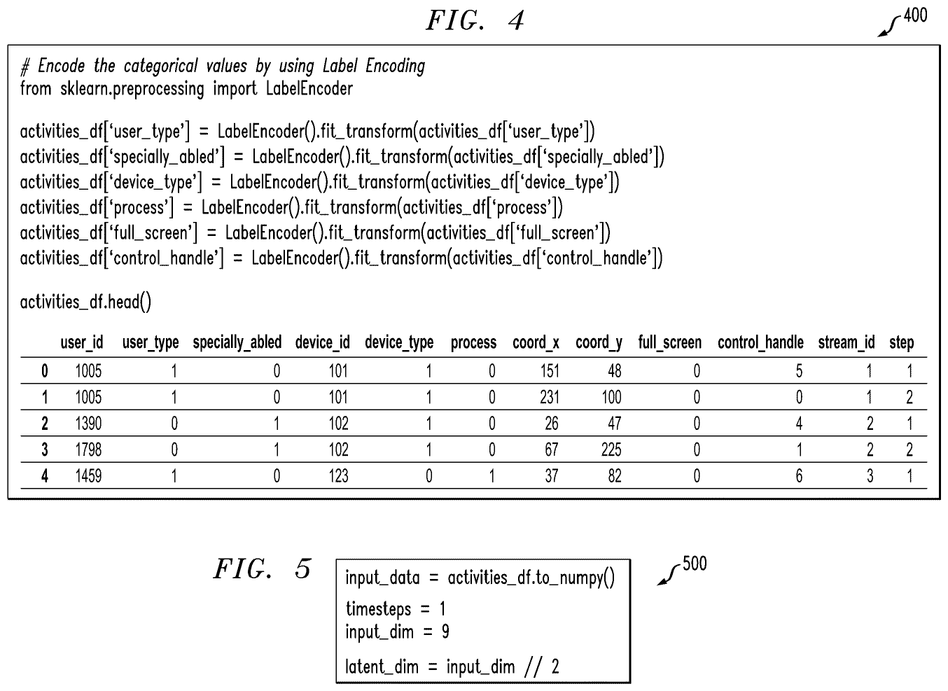

FIG. 4 shows example pseudocode for encoding textual values into numerical values in an illustrative embodiment. In this embodiment, example pseudocode 400 is executed by or under the control of at least one processing system and/or device. For example, the example pseudocode 400 may be viewed as comprising a portion of a software implementation of at least part of machine learning-based input device action prediction system 105 of the FIG. 1 embodiment.

The example pseudocode 400 illustrates encoding textual values into numerical values, as machine learning models (such as, e.g., LSTMs) process numerical values. Accordingly, textual categorical values in columns such as detailed, e.g., in connection with FIG. 3, must be encoded into numerical values. For example, categorical values such as, e.g., job name, job type, job outcome, etc., are encoded using LabelEncoder from a ScikitLearn library.

It is to be appreciated that this particular example pseudocode shows just one example implementation of encoding textual values into numerical values, and alternative implementations can be used in other embodiments.

FIG. 5 shows example pseudocode for implementing input data as a Numpy array in an illustrative embodiment. In this embodiment, example pseudocode 500 is executed by or under the control of at least one processing system and/or device. For example, the example pseudocode 500 may be viewed as comprising a portion of a software implementation of at least part of machine learning-based input device action prediction system 105 of the FIG. 1 embodiment.

The example pseudocode 500 illustrates implementing input data as a Numpy array, which can be obtained from a Pandas dataframe such as generated, for example, as detailed in connection with FIG. 3. Implementing input data as a Numpy array can include setting the timestep in the sequence and the input dimension, which is nine in the sample dataset depicted in FIG. 5. The latent dimension value is also set with the number of dimensions that the autoencoder compresses. In an example embodiment, this value can be set to 50% of the input dimension.

It is to be appreciated that this particular example pseudocode shows just one example implementation of implementing input data as a Numpy array, and alternative implementations can be used in other embodiments.

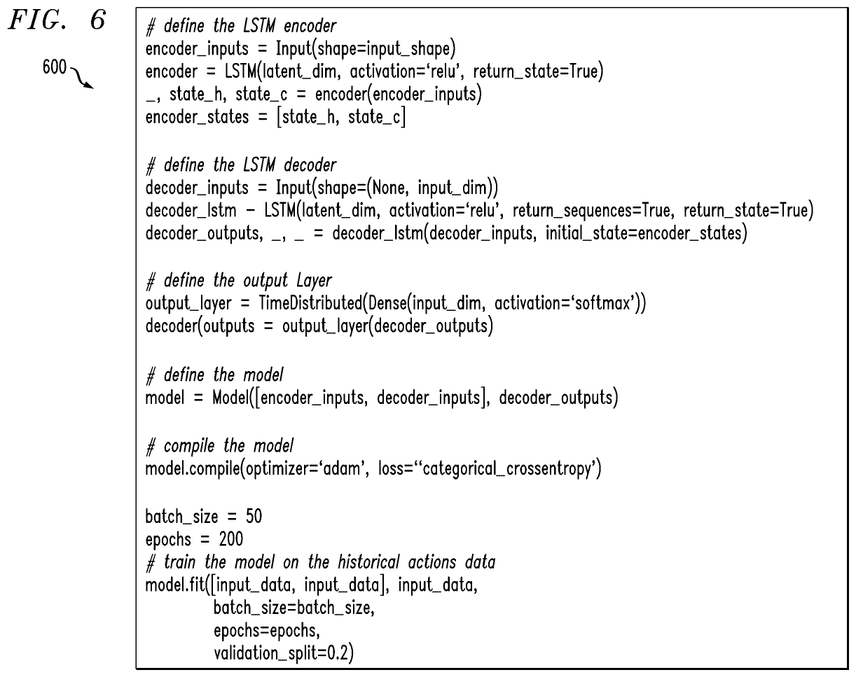

FIG. 6 shows example pseudocode for creating an autoencoder with LSTM-based encoder and decoder layers in an illustrative embodiment. In this embodiment, example pseudocode 600 is executed by or under the control of at least one processing system and/or device. For example, the example pseudocode 600 may be viewed as comprising a portion of a software implementation of at least part of machine learning-based input device action prediction system 105 of the FIG. 1 embodiment.

The example pseudocode 600 illustrates neural network model creation, specifically creating an autoencoder with LSTM-based encoder and decoder layers using a Keras library. More particularly, the example pseudocode 600 building the neural network using a Keras functional model, as separate encoder and decoder networks can be defined and/or created and added to the functional model. The example pseudocode 600 also illustrates using Adam as the optimizer and categorical_crossentropy as the loss function. Further, the example pseudocode 600 depicts training the created model using historical actions data.

It is to be appreciated that this particular example pseudocode shows just one example implementation of creating an autoencoder with LSTM-based encoder and decoder layers, and alternative implementations can be used in other embodiments.

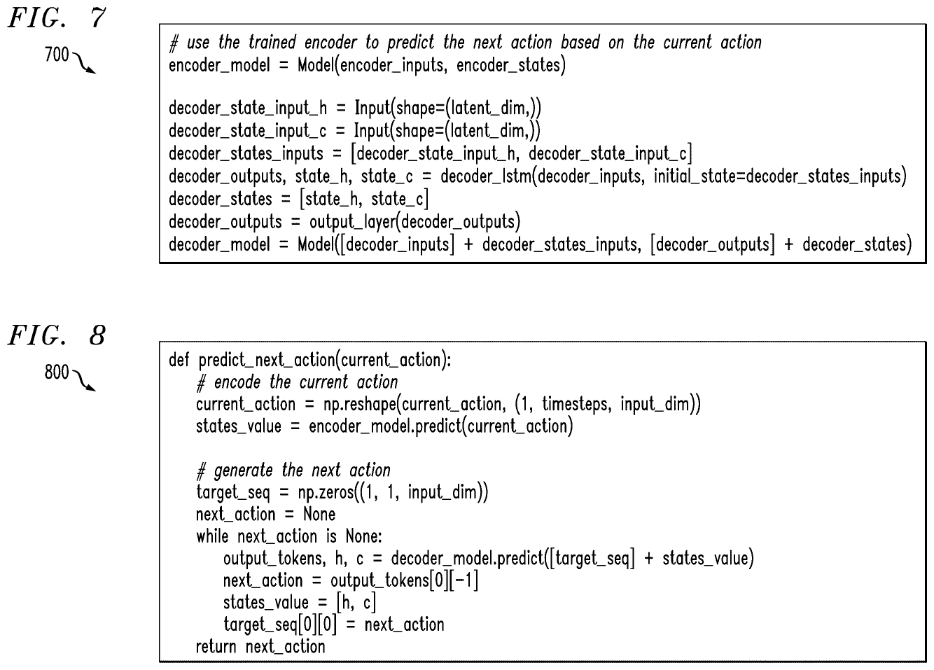

FIG. 7 shows example pseudocode for configuring an encoder model and a decoder model to predict the next action in a sequence in an illustrative embodiment. In this embodiment, example pseudocode 700 is executed by or under the control of at least one processing system and/or device. For example, the example pseudocode 700 may be viewed as comprising a portion of a software implementation of at least part of machine learning-based input device action prediction system 105 of the FIG. 1 embodiment.

The example pseudocode 700 illustrates setting-up a seq2seq model with separate encoder and decoder components. The encoder processes the input sequence and captures its contextual information in one or more internal states. The decoder then uses this contextual information to generate the output sequence, one step (or action) at a time. This architecture can be useful, for example, for tasks wherein the input and output sequences can be of different lengths and wherein the entire input sequence needs to be considered to generate each part of the output sequence (e.g., the next best action from the current action).

More particularly, example pseudocode 700 illustrates creating the encoder component of the seq2seq model by taking encoder_inputs as the input and producing encoder_states, which include the internal states of the LSTM layers in the encoder. These states capture the context of the input sequence. As also illustrated in example pseudocode 700, the decoder model generates the output sequence wherein decoder_state_input_h and decoder_state_input_c are inputs representing the internal states of the LSTM in the decoder. These states are initialized with the states from the encoder (encoder_states), allowing the decoder to start generating the output sequence based on the context provided by the encoder.

Additionally, example pseudocode 700 illustrates running the LSTM layer(s) in the decoder, initialized with the internal states from the encoder decoder_states_inputs. The decoder LSTM outputs decoder_outputs (e.g., the next action in the sequence) and its internal states (state_h and state_c). The output from the LSTM is then passed through an additional layer (output_layer), typically a dense layer with an activation function, to generate the final output. Further, the decoder model is defined with decoder_inputs and decoder_states_inputs (e.g., the initial states) as inputs, and the decoder model produces decoder_outputs (e.g., the predicted next action) and the updated internal states (decoder_states).

It is to be appreciated that this particular example pseudocode shows just one example implementation of configuring an encoder model and a decoder model to predict the next action in a sequence, and alternative implementations can be used in other embodiments.

FIG. 8 shows example pseudocode for predicting, using a trained model, the next action in a sequence of actions based on a current action in an illustrative embodiment. In this embodiment, example pseudocode 800 is executed by or under the control of at least one processing system and/or device. For example, the example pseudocode 800 may be viewed as comprising a portion of a software implementation of at least part of machine learning-based input device action prediction system 105 of the FIG. 1 embodiment.

The example pseudocode 800 illustrates using the model, once trained, to predict a future action by passing data pertaining to the current action to the predict ( ) function of the model. More particularly, example pseudocode 800 defines a function, predict_next_action, which predicts the next action in a sequence given the current action, using a trained encoder-decoder model. Also, example pseudocode 800 creates a predict_next_action function which can be called by passing the current action as input to return the next action.

It is to be appreciated that this particular example pseudocode shows just one example implementation of predicting the next action in a sequence of actions based on a current action, and alternative implementations can be used in other embodiments.

As detailed herein, one or more embodiments include implementing community learning techniques with respect to input device activity data based at least in part on historical movement data and historical action data associated with multiple users and multiple corresponding input devices within a given set of users (e.g., within a given enterprise and/or other organization). Such an embodiment further includes predicting and/or suggesting one or more actions and/or movements for a given user with respect to a given input device based at least in part on a current and/or previous action. Further, such predictions and/or suggestions can be based at least in part on actions (e.g., mouse clicks) that are common and/or popular among other users in similar scenarios and/or contexts. By factoring different users and/or user types (e.g., consumer and/or individual users versus commercial and/or business users), as well as their corresponding abilities and/or behaviors associated therewith, at least one embodiment can include generating input device action predictions and/or suggestions which can extend beyond one specific way of using the given input device.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on data pertaining to the current action and/or recent actions of an input device associated with a given user, as well as input device activity data associated with other users, and such recommendations and/or predictions can be used to initiate one or more automated actions (e.g., automatically outputting and/or displaying the recommendations and/or predictions via at least one interface in connection with the given application and a user device associated with the input device, and automatically initiating and/or executing at least a portion of the recommendations and/or predictions upon receiving user acceptance and/or approval).

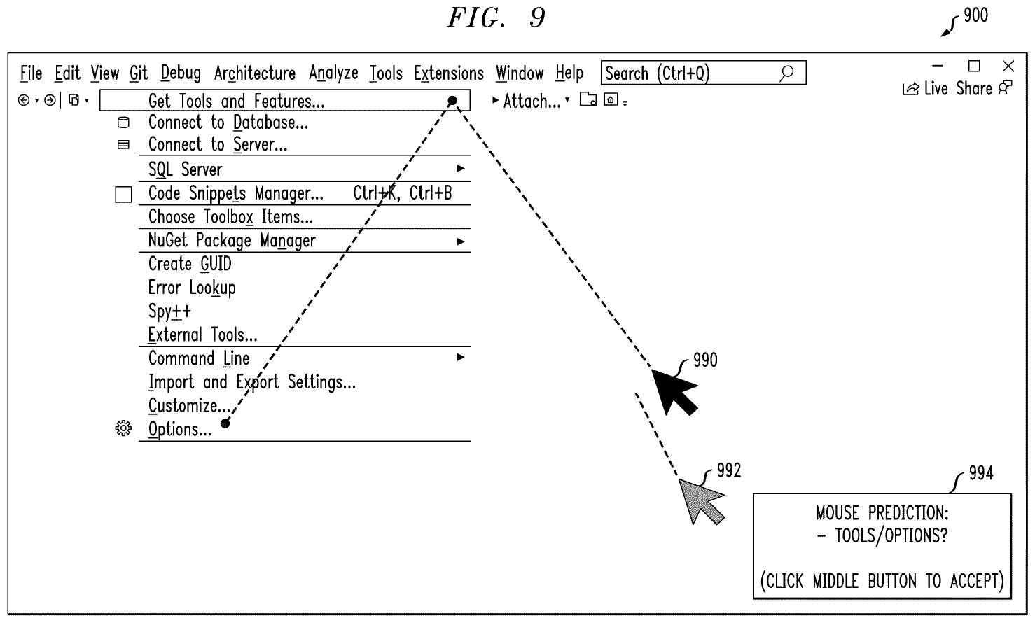

FIG. 9 is a diagram of an example display of a suggested input device action in connection with a given application in an illustrative embodiment. By way of illustration, FIG. 9 depicts an example visualization 900 of a generated output, in connection with a display and/or interface associated with a given application. Such an output can include a recommended action based at least in part on the most frequently used behavior of that specific user from historical data and/or a recommended action based at least in part on actions and/or movements taken by other users for the given application. For example, FIG. 9 depicts movement and action (e.g., option selecting and/or mouse clicking) recommendations 990 based at least in part on the current or immediately preceding movement of the input device 992 of the user of the given application. Additionally, in one or more embodiments, as depicted in FIG. 9, a prompt 994 may be displayed asking the user if the user would like to accept and/or approve the recommended movement and/or action, which includes an indication of what action to take (e.g., click middle button to accept) in order to initiate automated execution of the recommended movement and/or action.

FIG. 10 is a flow diagram of a process for predicting user input device activity using machine learning techniques in an illustrative embodiment. It is to be understood that this particular process is only an example, and additional or alternative processes can be carried out in other embodiments.

In this embodiment, the process includes steps 1000 through 1004. These steps are assumed to be performed by the machine learning-based input device action prediction system 105 utilizing elements 112, 114 and 116.

Step 1000 includes obtaining data pertaining to at least one of input device-related movement and input device-related action, and associated with a user using an application at a first temporal instance. In at least one embodiment, obtaining data includes obtaining a plurality of identifying information of the user, identifying information of the application, information pertaining to type of input device, pixel coordinates associated with the at least one of input device-related movement and input device-related action, identifying information of the input device-related action, and timestamp information associated with the at least one of input device-related movement and input device-related action.

Step 1002 includes predicting at least one of one or more input device-related movements and one or more input device-related actions to be carried out, at a second temporal instance subsequent to the first temporal instance, in connection with the user using the application, by processing at least a portion of the obtained data using one or more machine learning techniques. In one or more embodiments, predicting at least one of one or more input device-related movements and one or more input device-related actions includes processing the at least a portion of the obtained data using one or more deep neural network-based algorithms. In such an embodiment, processing the at least a portion of the obtained data using one or more deep neural network-based algorithms can include processing the at least a portion of the obtained data using at least one of one or more RNNs and one or more LSTM networks. Also, in such an embodiment, processing the at least a portion of the obtained data using one or more LSTM networks can include using one or more LSTM networks, trained in an unsupervised manner, in conjunction with at least one autoencoder architecture.

Step 1004 includes performing one or more automated actions based at least in part on the at least one of the one or more predicted input device-related movements and the one or more predicted input device-related actions. In at least one embodiment, performing one or more automated actions includes automatically outputting, via at least one interface implemented in connection with the application, the at least one of the one or more predicted input device-related movements and the one or more predicted input device-related actions. In such an embodiment, performing one or more automated actions can include automatically executing the at least one of the one or more predicted input device-related movements and the one or more predicted input device-related actions on the application upon receiving user instruction, subsequent to the outputting and via the at least one interface implemented in connection with the application, of the at least one of the one or more predicted input device-related movements and the one or more predicted input device-related actions. Additionally or alternatively, performing one or more automated actions can include automatically training at least a portion of the one or more machine learning techniques using feedback related to the at least one of the one or more predicted input device-related movements and the one or more predicted input device-related actions.

The techniques depicted in FIG. 10 can also include training the one or more machine learning techniques using input device-related movement data and input device-related action data derived from multiple users using one or more input devices on one or more applications. In such an embodiment, training the one or more machine learning techniques can include training at least two machine learning models comprising (i) training a first machine learning model using historical input device-related movement data and historical input device-related action data derived from the user using a given type of input device on the application, and (ii) training a second machine learning model using historical input device-related movement data and historical input device-related action data derived from multiple additional users using the given type of input device on the application.

Accordingly, the particular processing operations and other functionality described in conjunction with the flow diagram of FIG. 10 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to predict user input device activity using machine learning techniques. These and other embodiments can effectively overcome problems associated with time-consuming and repetitive physical user movements.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

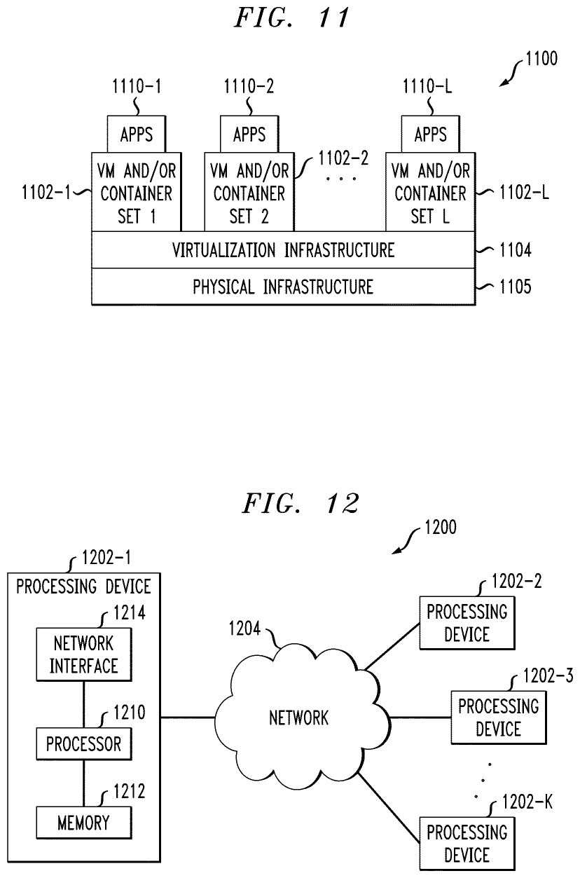

Illustrative embodiments of processing platforms will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that are utilized to implement at least a portion of the information processing system 100. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 comprise respective VMs, respective sets of one or more containers, or respective sets of one or more containers running in VMs. In some implementations of the FIG. 11 embodiment, the VMs/container sets 1102 comprise respective VMs implemented using virtualization infrastructure 1104 that comprises at least one hypervisor.

A hypervisor platform may be used to implement a hypervisor within the virtualization infrastructure 1104, wherein the hypervisor platform has an associated virtual infrastructure management system. The underlying physical machines comprise one or more information processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1202-1 in the processing platform 1200 comprises a processor 1210 coupled to a memory 1212.

The processor 1210 comprises a microprocessor, a CPU, a GPU, a TPU, a microcontroller, an ASIC, a FPGA or other type of processing circuitry, as well as portions or combinations of such circuitry elements.

The memory 1212 comprises random access memory (RAM), read-only memory (ROM) or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to at least one of input device-related movement and input device-related action, and associated with a user using an application at a first temporal instance;
predicting at least one of one or more input device-related movements and one or more input device-related actions to be carried out, at a second temporal instance subsequent to the first temporal instance, in connection with the user using the application, by processing at least a portion of the obtained data using one or more machine learning techniques; and
performing one or more automated actions based at least in part on the at least one of the one or more predicted input device-related movements and the one or more predicted input device-related actions;
wherein the method is performed by at least one processing device comprising a processor coupled to a memory.

2. The computer-implemented method of claim 1, further comprising:
training the one or more machine learning techniques using input device-related movement data and input device-related action data derived from multiple users using one or more input devices on one or more applications.

3. The computer-implemented method of claim 2, wherein training the one or more machine learning techniques comprises training at least two machine learning models comprising (i) training a first machine learning model using historical input device-related movement data and historical input device-related action data derived from the user using a given type of input device on the application, and (ii) training a second machine learning model using historical input device-related movement data and historical input device-related action data derived from multiple additional users using the given type of input device on the application.

4. The computer-implemented method of claim 1, wherein performing one or more automated actions comprises automatically outputting, via at least one interface implemented in connection with the application, the at least one of the one or more predicted input device-related movements and the one or more predicted input device-related actions.

5. The computer-implemented method of claim 4, wherein performing one or more automated actions comprises automatically executing the at least one of the one or more predicted input device-related movements and the one or more predicted input device-related actions on the application upon receiving user instruction, subsequent to the outputting and via the at least one interface implemented in connection with the application, of the at least one of the one or more predicted input device-related movements and the one or more predicted input device-related actions.

6. The computer-implemented method of claim 1, wherein predicting at least one of one or more input device-related movements and one or more input device-related actions comprises processing the at least a portion of the obtained data using one or more deep neural network-based algorithms.

7. The computer-implemented method of claim 6, wherein processing the at least a portion of the obtained data using one or more deep neural network-based algorithms comprises processing the at least a portion of the obtained data using at least one of one or more recurrent neural networks (RNNs) and one or more long short-term memory (LSTM) networks.

8. The computer-implemented method of claim 7, wherein processing the at least a portion of the obtained data using one or more LSTM networks comprises using one or more LSTM networks, trained in an unsupervised manner, in conjunction with at least one autoencoder architecture.

9. The computer-implemented method of claim 1, wherein obtaining data comprises obtaining a plurality of identifying information of the user, identifying information of the application, information pertaining to type of input device, pixel coordinates associated with the at least one of input device-related movement and input device-related action, identifying information of the input device-related action, and timestamp information associated with the at least one of input device-related movement and input device-related action.

10. The computer-implemented method of claim 1, wherein performing one or more automated actions comprises automatically training at least a portion of the one or more machine learning techniques using feedback related to the at least one of the one or more predicted input device-related movements and the one or more predicted input device-related actions.

11. A non-transitory processor-readable storage medium having stored therein program code of one or more software programs, wherein the program code when executed by at least one processing device causes the at least one processing device:
to obtain data pertaining to at least one of input device-related movement and input device-related action, and associated with a user using an application at a first temporal instance;
to predict at least one of one or more input device-related movements and one or more input device-related actions to be carried out, at a second temporal instance subsequent to the first temporal instance, in connection with the user using the application, by processing at least a portion of the obtained data using one or more machine learning techniques; and
to perform one or more automated actions based at least in part on the at least one of the one or more predicted input device-related movements and the one or more predicted input device-related actions.

12. The non-transitory processor-readable storage medium of claim 11, wherein the program code when executed by the at least one processing device causes the at least one processing device:
to train the one or more machine learning techniques using input device-related movement data and input device-related action data derived from multiple users using one or more input devices on one or more applications.

13. The non-transitory processor-readable storage medium of claim 12, wherein training the one or more machine learning techniques comprises training at least two machine learning models comprising (i) training a first machine learning model using historical input device-related movement data and historical input device-related action data derived from the user using a given type of input device on the application, and (ii) training a second machine learning model using historical input device-related movement data and historical input device-related action data derived from multiple additional users using the given type of input device on the application.

14. The non-transitory processor-readable storage medium of claim 11, wherein performing one or more automated actions comprises:
automatically outputting, via at least one interface implemented in connection with the application, the at least one of the one or more predicted input device-related movements and the one or more predicted input device-related actions; and
automatically executing the at least one of the one or more predicted input device-related movements and the one or more predicted input device-related actions on the application upon receiving user instruction, subsequent to the outputting and via the at least one interface implemented in connection with the application, of the at least one of the one or more predicted input device-related movements and the one or more predicted input device-related actions.

15. The non-transitory processor-readable storage medium of claim 11, wherein predicting at least one of one or more input device-related movements and one or more input device-related actions comprises processing the at least a portion of the obtained data using one or more deep neural network-based algorithms comprising at least one of one or more RNNs and one or more LSTM networks.

16. An apparatus comprising:
at least one processing device comprising a processor coupled to a memory;
the at least one processing device being configured:
to obtain data pertaining to at least one of input device-related movement and input device-related action, and associated with a user using an application at a first temporal instance;
to predict at least one of one or more input device-related movements and one or more input device-related actions to be carried out, at a second temporal instance subsequent to the first temporal instance, in connection with the user using the application, by processing at least a portion of the obtained data using one or more machine learning techniques; and
to perform one or more automated actions based at least in part on the at least one of the one or more predicted input device-related movements and the one or more predicted input device-related actions.

17. The apparatus of claim 16, wherein the at least one processing device is further configured:
to train the one or more machine learning techniques using input device-related movement data and input device-related action data derived from multiple users using one or more input devices on one or more applications.

18. The apparatus of claim 17, wherein training the one or more machine learning techniques comprises training at least two machine learning models comprising (i) training a first machine learning model using historical input device-related movement data and historical input device-related action data derived from the user using a given type of input device on the application, and (ii) training a second machine learning model using historical input device-related movement data and historical input device-related action data derived from multiple additional users using the given type of input device on the application.

19. The apparatus of claim 16, wherein performing one or more automated actions comprises:
automatically outputting, via at least one interface implemented in connection with the application, the at least one of the one or more predicted input device-related movements and the one or more predicted input device-related actions; and
automatically executing the at least one of the one or more predicted input device-related movements and the one or more predicted input device-related actions on the application upon receiving user instruction, subsequent to the outputting and via the at least one interface implemented in connection with the application, of the at least one of the one or more predicted input device-related movements and the one or more predicted input device-related actions.

20. The apparatus of claim 16, wherein predicting at least one of one or more input device-related movements and one or more input device-related actions comprises processing the at least a portion of the obtained data using one or more deep neural network-based algorithms comprising at least one of one or more RNNs and one or more LSTM networks.
